(19) United States
(12) Patent Application Publication
(10) Pub. No.: US 2026/0111766 A1
(43) Pub. Date: Apr. 23, 2026

(54) LANGUAGE MODEL FEDERATION FOR HYPOTHESIS EVALUATION AND REDUCED HALLUCINATION

(71) Applicant: International Business Machines Corporation, Armonk, NY (US)

(72) Inventors: Lokesh MISHRA, Bern (CH); Gerhard Ingmar MEIJER, Zurich (CH); Michele DOLFI, Zurich (CH); Peter Willem Jan STAAR, Zurich (CH)

(21) Appl. No.: 18/922,864

(22) Filed: Oct. 22, 2024

(51) Int. Cl. G06N 5/04

(52) U.S. Cl. CPC G06N 5/04

(57) ABSTRACT

Methods and apparatuses for federated language models are provided. A query including a question and a proposed answer is accessed for evaluation using machine learning. A corpus is accessed, and a set of hyperedges is generated based on the corpus of information, where each hyperedge links a set of related concepts from the corpus. Based on the question, a context for the question is identified, where the context comprises a set of relevant hyperedges. A set of candidate answers is generated based on processing the question and the context using one or more language models. A set of regression scores is generated based on processing the question, the context, and the proposed answer using one or more regression models. The proposed answer is evaluated based on the candidate answers and the regression scores. Based on the evaluation, an indication that the proposed answer is not valid is output.

### BACKGROUND

The present disclosure relates to machine learning, and more specifically, to language model federation and reducing model hallucinations.

A wide variety of machine learning models have been trained to perform a wide variety of tasks, including evaluating inputs, classifying or scoring data, generating new data (e.g., images and text), and the like. Recently, language models have been trained to generate textual output based on input prompts. However, many language models suffer from hallucination, where the model generates incorrect or misleading output.

### SUMMARY

According to some embodiments of the present disclosure, a method is provided. The method includes accessing a query comprising a question and a proposed answer for evaluation using machine learning; accessing a corpus of information; generating a set of hyperedges based on the corpus of information, wherein each respective hyperedge of the set of hyperedges links a respective set of related concepts from the corpus of information; identifying, based on the question, a context for the question, wherein the context comprises a set of relevant hyperedges from the set of hyperedges; generating a set of candidate answers based on processing the question and the context using one or more language models; generating a first set of regression scores based on processing the question, the context, and the proposed answer using one or more regression models; evaluating the proposed answer based on the set of candidate answers and the first set of regression scores; and outputting, based on the evaluation, an indication that the proposed answer is not valid.

According to some embodiments of the present disclosure, one or more non-transitory computer readable media containing, in any combination, computer program code that, when executed by operation of any combination of one or more processors, performs the above method, and/or a system, comprising one or more processors and one or more memories storing a program, which, when executed on any combination of the one or more processors, performs the above method, are also provided.

### BRIEF DESCRIPTION OF THE DRAWINGS

FIG. 1 depicts an example computing environment for the execution of at least some of the computer code involved in performing the inventive methods.

FIG. 2 depicts an example workflow for language model federation, according to some embodiments of the present disclosure.

FIG. 3 depicts an example system for generating machine learning model output using language model federation and evaluation, according to some embodiments of the present disclosure.

FIG. 4 is a flow diagram depicting an example method for generating machine learning model output using language model federation and evaluation, according to some embodiments of the present disclosure.

FIG. 5 is a flow diagram depicting an example method for machine learning, according to some embodiments of the present disclosure.

### DETAILED DESCRIPTION

Embodiments of the present disclosure provide techniques for improved machine learning using a federation of language models with operations to validate output and prevent (or reduce) model hallucination.

Although recent improvements have been made to the accuracy of machine learning models, many popular architectures (such as language models) suffer from frequent hallucination. That is, the output of these models if often nonsensical or inaccurate. In some cases, the output is not only inaccurate, but also appears highly convincing. That is, many modern model architectures generate output that at least appears plausible, and some models have even been known to hallucinate references and sources for the inaccurate information (where these references and sources are, themselves, also hallucinations). As a result, modern architectures may be useful for some tasks (e.g., summarizing brief portions of text), but are entirely impractical for a wide variety of common problems. For example, in many settings, language models simply cannot be trusted to provide truthful and accurate information in response to a query.

Embodiments of the present disclosure provide techniques to use and evaluate a variety of machine learning models to provide accurate output. For example, in some embodiments, techniques for evaluating a hypothesis (e.g., expressed as question-answer pair) using a corpus of ground-truth information can be provided by federating multiple machine-learned models and testing for hallucinations. In some embodiments, federating multiple language models and multiple regression models, which may be trained for different and/or special behaviors, can be used to create a system of checks and balances for evaluating the truthfulness and quality of answers, such as by comparing the answer(s) with information from a corpus of ground-truth data.

In some embodiments, a query comprising a question and a proposed answer is accessed for evaluation using machine learning. A corpus of information may also be accessed, and a set of hyperedges may be generated based on the corpus of information, where each respective hyperedge of the set of hyperedges links a respective set of related concepts from the corpus of information. Based on the question, a context for the question can be identified, where the context comprises a set of relevant hyperedges from the set of hyperedges. In some embodiments, a set of candidate answers can be generated based on processing the question and the context using one or more language models. Further, a first set of regression scores is be generated based on processing the question, the context, and the proposed answer using one or more regression models. The proposed answer can then be evaluated based on the set of candidate answers and the first set of regression scores, and based on the evaluation, an indication that the proposed answer is not valid can be output. Advantageously, using a federation of language models and regression models, as well as subsequent evaluation or verification of the generated data, embodiments of the present disclosure can substantially improve the model output, reducing or eliminating hallucinations and inaccuracies.

In some embodiments, identifying the context comprises searching the set of hyperedges, based on the question, using at least one of (i) keyword searching, (ii) structured query language searching, or (iii) semantic searching. Advantageously, this identification of the context can improve model accuracy by enabling focus on the core relevance, as well as reduce computational expense of the machine learning process by reducing the amount of data to be analyzed at each step.

In some embodiments, the first set of regression scores comprises a first regression score indicating at least one of (i) similarity between the proposed answer and the context, (ii) whether the proposed answer contains one or more disallowed concepts, (iii) whether the question, proposed answer, and context are in a same language, or (iv) whether the proposed answer contradicts the context. Advantageously, these regression scores can be used to improve validation accuracy and prevent (or reduce) hallucination in the mode output.

In some embodiments, evaluating the proposed answer includes generating a first set of similarity scores between the proposed answer and the set of candidate answers. The evaluation may further include generating a second set of similarity scores between the proposed answer and the context. The evaluation may further include generating a third set of similarity scores between the proposed answer and the question. In some embodiments, the evaluation may further include aggregating the first, second, and third sets of similarity scores with the first set of regression scores. Advantageously, some or all of these similarity measures can be used to ensure the accuracy of the generated output, reducing hallucinations and improving model performance.

In some embodiments, at least a portion of the context is also output along with the response. Advantageously, this can provide a more specific context justifying the response, such as to indicate which specific portion(s) of the corpus support the returned answer(s).

In some embodiments, a second set of regression scores can be generated based on processing the question, the context, and a first candidate answer of the set of candidate answers using one or more regression models. The first candidate answer can then be evaluated based on the set of candidate answers and the second set of regression scores, and the first candidate answer may be output based on the evaluation. Advantageously, such an embodiment allows the system to generate a new (correct) answer to the query, even if the provided answer is inaccurate.

In some embodiments, the query and the corpus of information are indicated in a request from a user. Advantageously, this can allow the user to control or provide the relevant source(s) that should be searched to find an appropriate answer. This can reduce computational expense (e.g., obviating the need to search a broader library) while also improving the accuracy of the output (particularly if the query is specifically targeting information in the corpus).

In some embodiments, generating the set of hyperedges includes generating a hypergraph based on the corpus of information, where the hypergraph includes a plurality of nodes representing concepts from the corpus of information. The hypergraph may further include a plurality of hyperedges representing relationships among the concepts from the corpus of information, where each respective hyperedge of the plurality of hyperedges comprises a respective probabilistic weight indicating a probability that a corresponding set of concepts are related. In some embodiments, it can be determined whether the set of hyperedges are coherent based on the probabilistic weights. Advantageously, this generation and evaluation of hyperedges can reduce the computational expense of the process (as hyperedges may be smaller and less computationally expensive to evaluate and parse, as compared to other forms of context).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the language model federator 180. In addition to the language model federator 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the language model federator 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

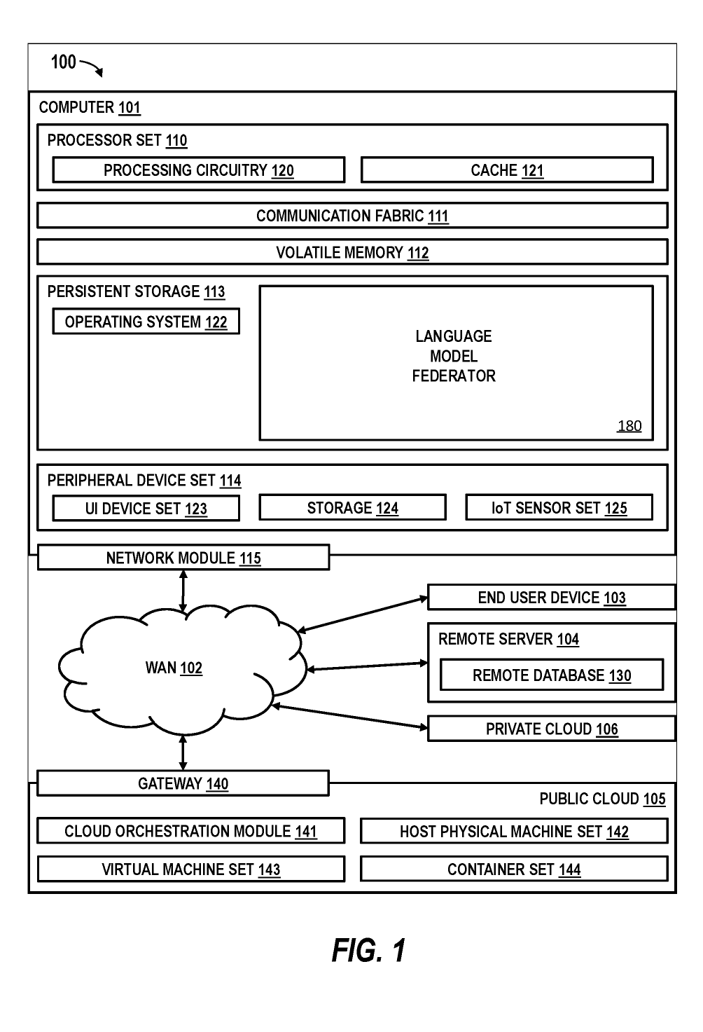

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the language model federator 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the language model federator 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 105 and 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

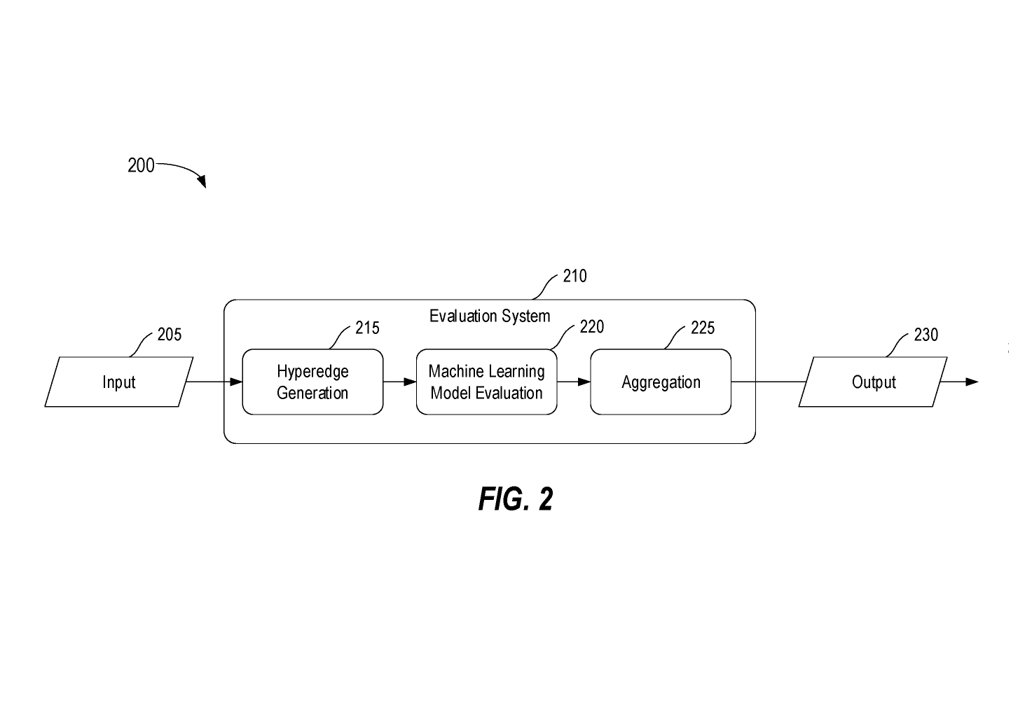

FIG. 2 depicts an example workflow 200 for language model federation, according to some embodiments of the present disclosure.

In the illustrated workflow 200, an input 205 is accessed by an evaluation system 210 and processed to generate an output 230. As used herein, “accessing” data may generally include receiving, requesting, retrieving, obtaining, generating, collecting, or otherwise gaining access to the data. For example, the input 205 may be received from a user, or from another system or application. Although depicted as a discrete computing system for conceptual clarity, in some embodiments, the evaluation system 210 may be implemented using hardware, software, or a combination of hardware and software distributed across any number and variety of computing systems. In some embodiments, the language model federator 180 of FIG. 1 may be implemented or hosted by the evaluation system 210.

In the illustrated workflow 200, the evaluation system 210 may perform a sequence of operations to evaluate the input 205 and generate the output 230. Although depicted as a sequence of conceptual clarity, in some embodiments, the evaluation system 210 may perform the depicted operations in any order (including in parallel), and may further perform one or more additional operations not depicted (or may refrain from performing one of more depicted operations). In some embodiments, the input 205 generally corresponds to a query for information and/or validation of information. In some embodiments, the input 205 may include a natural language question for which the user (or other requesting entity) would like answer. For example, the input 205 may include natural language text such as “What were the total emissions of Company A in 2020?”

In some embodiments, the input 205 can also include a natural language proposed answer to the question. For example, the input 205 may give a proposed natural language answer such as “2,594 metric tons of carbon dioxide equivalent.” In some embodiments, in addition to or rather than containing a discrete question and answer, the input 205 may include a natural language hypothesis (e.g., “Company A’s emissions in 2020 were 2,594 metric tons of carbon dioxide equivalent.”). In some embodiments, the evaluation system 210 (or another system) may formulate a question and proposed answer based on this hypothesis.

In some embodiments, the input 205 may also include (or specify) a corpus of information to be used to evaluate the question and/or answer. For example, continuing the above example, the corpus may correspond to an environmental, social, and governance (ESG) and corporate governance report provided by “Company A” to potential investors. Generally, the particular contents and context of the input 205 may vary depending on the particular implementation and task. For example, the corpus may correspond to a lengthy or multitudinous collection of documents, and the task may be fact-checking a summary sheet (e.g., a page giving the high level values for one or more metrics that are supported by the documents, such as the total expenditures in a given quarter).

In the illustrated example, the evaluation system 210 may perform operations including hyperedge generation 215, machine learning model evaluation 220, and/or aggregation 225 to generate the output 230. Generally, each depicted operation may include performing any number and variety of additional operations, as discussed in more detail below.

In some embodiments, the hyperedge generation 215 can include processing the corpus of information using one or more techniques to generate and/or extract hyperedges from the corpus, as discussed in more detail below. In some embodiments, the hyperedge generation 215 may include extraction of entities (e.g., names, dates, objects, locations, and the like) from the corpus, and generating a set of nodes (one for each identified entity). For example, nodes may correspond to concepts such as “carbon dioxide equivalent,” “2020,” “emissions,” “factory,” “transportation,” “Country A,” and the like. Edges may then be generated linking the nodes, where each edge indicates a relationship or relevancy between the corresponding node endpoints. In some embodiments, the edges may have associated weights or scores indicating the probability that the nodes are coherently related. For example, concepts such as “emission” and “carbon dioxide equivalent” may have a strong weight indicating a high probability that these terms are related or relevant to each other. In some embodiments, these edges may further be processed to generate hyperedges (e.g., edges that can connect to more than two nodes). The hyperedges may similarly have probabilistic weights indicating the probability that the set of nodes (connected by the hyperedge) are coherently related.

In some embodiments, based on the set of coherent hyperedges, the hyperedge generation 215 may include identifying a relevant subset of hyperedges that are relevant for the input 205. For example, based on the particular question posed by the input 205, the evaluation system 210 may identify a subset of the coherent hyperedges that are relevant for or related to the question (e.g., using keyword searching or other techniques). In some embodiments, this subset of relevant coherent hyperedges may be referred to as the “context” for the input 205 and/or question.

In the illustrated workflow 200, the machine learning model evaluation 220 may generally include using one more machine learning models to evaluate one or more portions of the input 205 and/or the context in order to generate outputs such as predictions, classifications, alternative candidate answers, and the like. In some embodiments, the machine learning model evaluation 220 can include using a federation of multiple language models (e.g., large language models (LLMs), which may be trained or specialized for differing tasks or contexts, to generate a set of candidate answers to the prompt. For example, the evaluation system 210 may use the question of the input 205 as the prompt and the context (determined during hyperedge generation) as the corpus, and ask each of the language models to generate a candidate answer (also referred to in some embodiments as a “test answer”) to the question based on the context.

In some embodiments, the machine learning model evaluation 220 may further include using one or more regression machine learning models to generate one or more regression scores based on the input 205. In some embodiments, the regression models may each be trained to answer one or more binary questions (e.g., where the answer is yes or no, and the regression score indicates a probability that the answer is yes). In some embodiments, the federation of regression models may be used as one portion of the answer verification process. For example, the regression models may include a model trained to generate a score indicating the similarity between the proposed answer (given in the input 205 and the context (determined during the hyperedge generation 215) (e.g., the semantic similarity of the two).

In some embodiments, the regression scores may include a score indicating whether the proposed answer contains one or more disallowed concepts (also referred to as “toxic” concepts in some embodiments). For example, this score may be used as a guardrail to prevent the evaluation system 210 from generating potentially offensive outputs. Generally, the “disallowed” concepts may correspond to a set of manually defined and/or curated concepts about which the evaluation system 210 should not generate output (or which should not be included in the generated output). For example, depending on the particular use case and implementation, an administrator may decide that the evaluation system 210 should not generate output denigrating religious or ethnic groups. In some embodiments, because machine learning models (particularly language models) may often generate such offensive or inappropriate output, such a regression model can be used to prevent harmful outputs.

In some embodiments, the regression scores may include a sore indicating whether the question, proposed answer, and the context are in the same language (e.g., all in English). If any are not, this may result in a low score (e.g., indicating that the answer may not be correct, because it is in a different language). As another example, in some embodiments, the regression scores may include a score indicating whether the proposed answer contradicts the context. Generally, the machine learning model evaluation 220 may include use of any number and variety of regression models to generate regression scores for the input 205. Generally, each score may correspond to or comprise a continuous value (e.g., a score between zero and one), a binary value (e.g., a zero indicating “no” or a one indicating “yes”), and the like.

In the illustrated workflow 200, the output of the machine learning model evaluation 220 and/or the hyperedge generation 215 are then processed using an operation for aggregation 225. In some embodiments, the aggregation 225 may alternatively be referred to as “vetting,” “verifying,” or “validating,” as discussed in more detail below. The aggregation 225 may generally involve evaluation of the proposed answer (given in the input 205), the set of candidate answers (generated during the machine learning model evaluation 220), and/or the set of regression scores (also generated during the machine learning model evaluation 220) in order to generate a response indicating whether the proposed answer is accurate or correct.

In some embodiments, the aggregation 225 may include evaluating the similarity between the proposed answer (provided in the input 205) and one or more other pieces of data, such as between the proposed answer and each of the candidate answers (generated using language models (LMs)), between the proposed answer and the context, between the proposed answer and the question, and the like. In some embodiments, the aggregation 225 may include aggregating these individual similarity scores and evaluations (along with the regression scores in some embodiments) to either accept or reject the answer. For example, the aggregation 225 may compute a weighted sum and/or average of the scores, and evaluate this sum and/or average using one or more criteria (e.g., one or more thresholds), where the proposed answer may be accepted if the criteria are satisfied (e.g., if the threshold(s) are exceeded). In some embodiments, the aggregation 225 may additionally or alternatively include evaluation of each individual score (e.g., using corresponding criteria, such as thresholds), and either accepting or rejecting the answer based on these individual evaluations.

In some embodiments, as discussed in more detail below, if the answer is rejected, the aggregation 225 (or another component) may determine to provide an alternative answer to the question. For example, the aggregation 225 (or another component) may select one of the candidate answers (generated during the machine learning model evaluation 220) as the true answer to the question (e.g., selecting the highest-scored candidate answer). In some embodiments, this candidate answer may then be used as the new “proposed answer” and the workflow 200 may return to the machine learning model evaluation 220 to evaluate the new proposed answer in a similar fashion to the above discussion. This process may repeat until a satisfactory answer is found (or until all candidate answers have been evaluated and rejected).

If an acceptable answer is found, the evaluation system 210 may provide the answer (which may be the original proposed answer or may be a candidate answer) with the output 230. In some embodiments, if no answer is accepted, the evaluation system 210 may provide a response indicating that the proposed answer is incorrect (or at least may not be correct), but that the true answer cannot be found in the provided corpus.

In some embodiments, the output 230 can include a portion of the context. For example, the evaluation system 210 may identify a subset of the context (e.g., a subset of the set of relevant and coherent hyperedges) that contain or support the answer to the question. By including this context with the output 230, the evaluation system 210 can enable the user (or other system) to rapidly confirm the accuracy of the output 230 (e.g., by immediately going to the location(s) in the original corpus, indicated by the provided hyperedges, where the support is allegedly found). In this way, the evaluation system 210 can not only verify or validate proposed answers, but can also provide alternative answers if needed, and can further pinpoint cite the particular portion(s) of the corpus that support the answer.

As discussed above, these operations can thereby substantially improve both the accuracy as well as the usefulness of the output 230, and can prevent (or at least substantially reduce) model hallucinations.

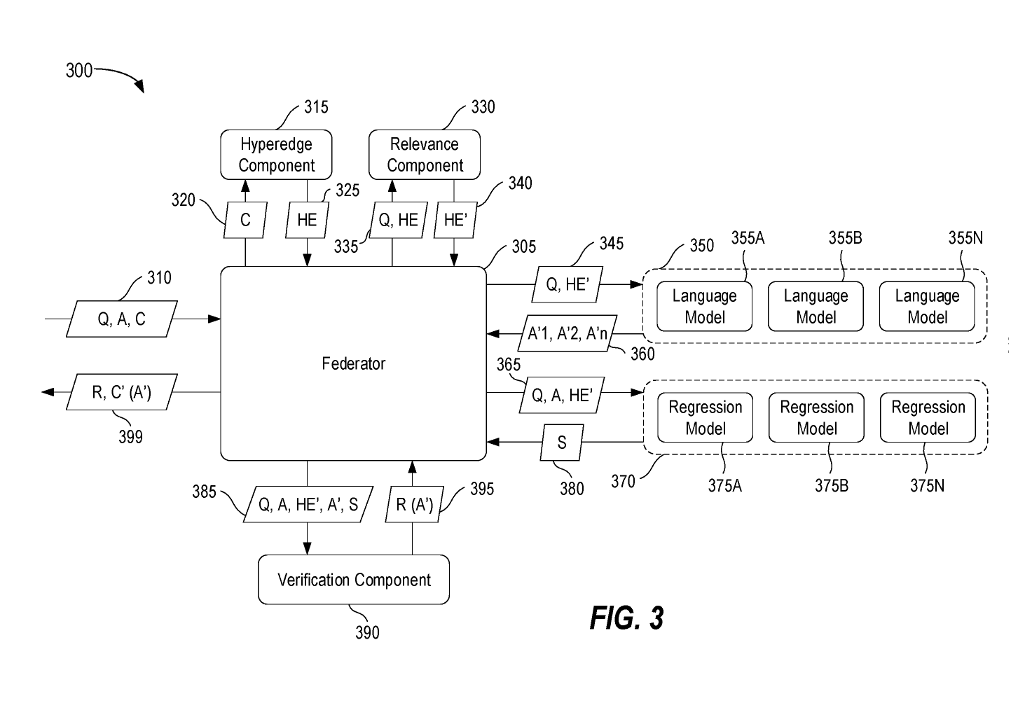

FIG. 3 depicts an example system 300 for generating machine learning model output using language model federation and evaluation, according to some embodiments of the present disclosure. In some embodiments, the system 300 corresponds to an evaluation system, such as the language model federator 180 of FIG. 1 and/or the evaluation system 210 of FIG. 2.

In the illustrated system 300, a federator 305 accesses an input query 310 (which may correspond to the input 205 of FIG. 2). For example, as discussed above, the query 310 may be provided by a user or other application or system. As illustrated, the query 310 may include or point to information such as a question (depicted as “Q” in the illustrated example), a proposed answer (depicted as “A”), and a corpus (denoted as “C”). For example, in some embodiments, the question and proposed answer can include natural language text (where the proposed answer is a purported or believed answer to the question). In some embodiments, the corpus may be included with the query 310, or the query 310 may include a link or pointer to where the corpus can be found. The corpus is generally a set of one or more natural language documents that (purportedly) can be used to answer the question. For example, the question may include “What was Company A’s total emissions in 2022,” the proposed answer (e.g., taken from a summary form) may be “2,594 metric tons carbon dioxide equivalent,” and the corpus may be a set of disclosures filed by Company A with one or more regulatory bodies.

As discussed above, the federator 305 may generally use a federation of machine learning models (e.g., language models and/or regression models) to generate a response to the query 310. In the illustrated example, the federator 305 may first provide data 320 including the corpus (“C”) to a hyperedge component 315. Although depicted as a discrete component for conceptual clarity, in some embodiments, the hyperedge component 315 may be implemented as a component of the federator 305. The hyperedge component 315 evaluates the corpus to generate and return data 325 including a set of hyperedges (designated “HE” in the illustrated example).

As discussed above, each hyperedge may generally specify a related or connected set of concepts extracted from the corpus. The hyperedge component 315 may use a variety of operations to generate the hyperedges. For example, in some embodiments, the hyperedge component 315 may parse the corpus to extract entities (e.g., locations, names, objects, and the like), and may then generate a graph having a set of nodes (each node corresponding to an entity) and edges (each edge connecting two nodes and indicating a probability that the two corresponding entities are related or linked). In some embodiments, the hyperedge component 315 may then parse this graph to generate a hypergraph (e.g., having hyperedges that can connect more than two nodes). Each hyperedge may similarly indicate a probability that the linked concepts are related. In some embodiments, rather than extracting entities and generating the graph, the hyperedge component 315 may use a machine learning model to parse the corpus to directly generate the hyperedges.

In some embodiments, the hyperedges correspond to the “coherent” hyperedges. That is, the hyperedge component 315 may evaluate the hyperedges to determine coherent linkages (e.g., entities which are truly related) as compared to incoherent linkages (e.g., entities which are not likely related). This evaluation may be performed, for example, based on the probabilistic scores associated with each hyperedge (where hyperedges with a sufficiently high score may be classified as coherent). In some embodiments, in addition to or instead of generating the hyperedges, the hyperedge component 315 may access a set of previously generated hyperedges (e.g., hyperedges with the same or similar concepts as reflected in the corpus, or relating to a similar or the same documentation).

In the illustrated example, the federator 305 then provides data 335 including the question (“Q”) and the set of coherent hyperedges (“HE”) to a relevance component 330. Although depicted as a discrete component for conceptual clarity, in some embodiments, the relevance component 330 may be implemented as a component of the federator 305. The relevance component 330 may generally be used to identify or retrieve relevant or useful information from the set of hyperedges based on the question. In some embodiments, these relevant hyperedges may be referred to as the “context” for the query 310. Generally, the relevance component 330 may use a variety of operations to identify the relevant context from the set of hyperedges. For example, in some embodiments, the relevance component 330 may use operations such as keyword search (e.g., searching the hyperedges based on keywords extracted from the question), a structured query language (SQL) search of the hyperedges (based on the question), a vector search (e.g., to identify the hyperedges nearest to the question in the vector space), and the like. In some embodiments, the relevance component 330 returns the top-K hyperedges as the context. In the illustrated example, the relevance component 330 returns data 340 including this context (denoted “HE’” in the illustrated example). In some embodiments, the hyperedge component 315 and/or the relevance component 330 may correspond to or perform the operations of the hyperedge generation 215 of FIG. 2.

As illustrated, the federator 305 then provides data 345 including the question (“Q”) and the context (“HE’”) to a federation 350 of language models 355A-N. Although depicted as a discrete component for conceptual clarity, in some embodiments, the federation 350 may be implemented as a component of the federator 305. As discussed above, each language model 355A-N (collectively, language models 355) may generally correspond to a machine learning model trained to generate textual output based on textual input. For example, some or all of the language models 355 may correspond to LLMs. In some embodiments, as discussed above, the language models 355 may have been trained on different data and/or with different hyperparameters, or may generally be trained to perform (at least somewhat) different tasks. That is, each language model 355 may be trained to generate textual outputs in different ways and/or with different levels of specialty, detail, depth, and the like.

Although the illustrated federation 350 includes three language models, in embodiments, there may be any number of language models 355 in the federation 350. In some embodiments, each language model 355 may process the question Q as input, using the context HE’ as the context input to the language model 355. In some embodiments, each language model is used to generate a corresponding candidate answer. In the illustrated example, the federation 350 returns data 360 including three candidate answers, denoted “A’₁,” “A’₂,” and ““A’₃” in the depicted example.

As illustrated, the federator 305 also provides data 365 including the question (“Q”), the proposed answer (“A”), and the context (“HE’”) to a federation 370 of regression models 375A-N. Although depicted as a discrete component for conceptual clarity, in some embodiments, the federation 370 may be implemented as a component of the federator 305. As discussed above, each regression model 375A-N (collectively, regression models 375) may generally correspond to a machine learning model trained to generate predictions or classifications for binary determinations (e.g., outputting binary values and/or outputting scores between zero and one indicating the probability of a given classification). For example, as discussed above, the regression models 375 may have been trained to generate regression scores indicating whether the proposed answer (A) is similar to the context (HE’), whether the proposed answer contains toxicity or disallowed terms or concepts, whether the proposed answer is in the same language as the question and/or context, whether the proposed answer contradicts the context, and the like.

Although the illustrated federation 370 includes three regression models, in embodiments, there may be any number of regression models 375 in the federation 370. In the illustrated example, the federation 370 returns data 380 including three regression scores, denoted “S” in the depicted example. In some embodiments, the federations 350 and 370 may operate entirely or partially in parallel. That is, the federator 305 may transmit the data 345 and the data 365 to each federation at the same time, rather than waiting for sequential execution. In some embodiments, the federation 350 and/or the federation 370 may correspond to or perform the operations of the machine learning model evaluation 220 of FIG. 2.

In the illustrated system 300, the federator 305 can then provide data 385 including the question Q and proposed answer A (from the query 310), the context HE’ (generated by the relevance component 330), the set of candidate answers A’ (generated by the federation 350 of language models 355), and the set of regression scores S (generated by the federation 370 of regression models 375) to a verification component 390. Although depicted as a discrete component for conceptual clarity, in some embodiments, the verification component 390 may be implemented as a component of the federator 305. In some embodiments, the verification component 390 may correspond to or perform the operations of the aggregation 225 of FIG. 2.

The verification component 390 may generally be used to perform verification of the proposed answer (also referred to as validation and/or vetting in some aspects). In some embodiments, the verification component 390 may aggregate the available information (reflected in the data 385) to attempt to verify that the proposed answer is correct. The verification component 390 may generally use a variety of operations and techniques to evaluate and/or validate the answer. For example, in some embodiments, the verification component 390 may compute one or more similarity scores between the proposed answer and the context, each of the candidate answers, the question, and the like. Generally, a wide variety of similarity scores may be used, including a hyperedge score, morphological scores, semantic scores, the Levenshtein distance, the Hamming distance, the indel distance, the partial ratio, a set of rouge scores, bilingual evaluation understudy (BLEU) scores, bidirectional encoder representations from transformers (BERT) scores, and the like.

For example, the verification component 390 may compute a respective similarity score between the proposed answer and each respective candidate answer of the set of candidate answers, a similarity score between the proposed answer and the question, a similarity score between the proposed answer and the context, and the like. In some embodiments, these similarity scores may be aggregated, along with the regression scores, to generate an overall validation score for the proposed answer. For example, as discussed above, the verification component 390 may aggregate the similarity scores (e.g., summing or averaging them), and determine whether the aggregate score meets or exceeds a threshold (or satisfies some other criteria). As another example, the verification component 390 may compare each regression score against one or more thresholds (e.g., where scores below or above the threshold may indicate that the answer is likely invalid, such as if the answer is in a different language or contains disallowed concepts).

In the illustrated example, the verification component 390 returns data 395 including a response (denoted as “R”). The response generally indicates whether the proposed answer is verified or valid (e.g., correct), or is invalid. In some embodiments, as indicated by “(A’)”, the data 395 may also include an alternative answer in some aspects. For example, if the verification component 390 determines that the proposed answer is incorrect, the verification component 390 may select one of the candidate answers to provide as an alternative (e.g., more correct) answer to the question. For example, in some embodiments, the verification component 390 may select one of the candidate answers (e.g., randomly, or computing similarity scores between each candidate answer and the context, question, and/or other candidate answers and then selecting the highest scored candidate answer).

In some embodiments, the federator 305 may then provide this selected candidate answer to the federation 370 of regression models 375 (e.g., providing updated data 365 including the question Q, the context HE’, and the newly selected candidate answer A’ instead of the proposed answer A). The federation 370 may generate a set of regression scores for this candidate answer, as discussed above. In some embodiments, the federator 305 may then again task the verification component 390 with validating the selected candidate score A’ (as if it was the proposed answer) based on the updated regression scores.

Generally, this process may be repeated any number of times until either one of the candidate answers is validated, or all candidate answers have been evaluated and found invalid. As illustrated, the federator 305 may transmit data 399 (which may correspond to the output 230 of FIG. 2) to the requesting entity (e.g., the user or application that provided the query 310) including the response (R, generated by the verification component 390 to indicate whether the originally proposed answer is correct). In some embodiments, the data 399 may also include a portion of the context (denoted “C’” in the illustrated example). For example, this portion of the context may be a subset of the hyperedges that support or justify the response (e.g., one or more hyperedges, from the context, that were scored most highly by the verification component 390 with respect to the answer). In some embodiments, this portion of the context may include quotations, links or pointers to the location(s) in the corpus from which the hyperedges were generated, and the like.

In the illustrated example, if the proposed answer is found invalid, the data 399 may also include the selected (and verified) candidate answer A’, if any. In some embodiments, if all candidate answers were also found to be invalid, the data 399 may indicate that a satisfactory answer could not be found or generated, suggesting that the question may be malformed and/or that the answer may not be found in the corpus.

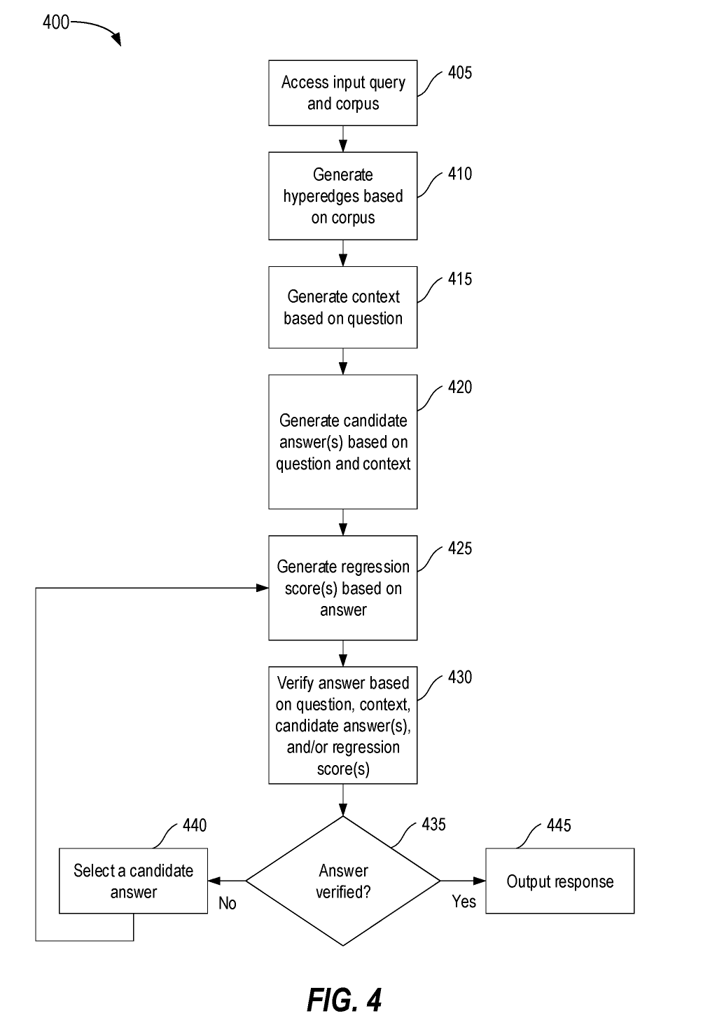

FIG. 4 is a flow diagram depicting an example method 400 for generating machine learning model output using language model federation and evaluation, according to some embodiments of the present disclosure. In some embodiments, the method 400 may be performed by an evaluation system, such as the language model federator 180 of FIG. 1, the evaluation system 210 of FIG. 2, and/or the evaluation system discussed above with reference to FIG. 3.

At block 405, the evaluation system accesses an input query and a corpus (e.g., the input 205 of FIG. 2 and/or the query 310 of FIG. 3). For example as discussed above, the query may include a question and a proposed answer (or may be a statement that can be parsed to generate a question and a proposed answer), and the corpus may correspond to a set of one or more documents (e.g., containing natural language text) that may contain a true answer to the question.

At block 410, the evaluation system generates a set of hyperedges (e.g., corresponding to the data 325 of FIG. 3) based on the corpus. For example, as discussed above, the evaluation system may extract entities from the corpus and generate hyperedges, where each hyperedge connects a set of related entities and has a probabilistic score indicating the probability that the set of related entities are truly related. In some embodiments, as discussed above, hyperedges with sufficiently high probability may be referred to as coherent hyperedges. The evaluation system may generally use a variety of techniques to generate the hyperedges.

At block 415, the evaluation system generates a context (e.g., corresponding to the data 340 of FIG. 3) for the query based on the question. For example, as discussed above, the evaluation system may query or search the total set of hyperedges based on the question of the query in order to identify relevant hyperedges that are most similar to the question. In some embodiments, as discussed above, this set of the most relevant hyperedges (e.g., the top K, where K may be a hyperparameter) may be used as the context for evaluating the query.

At block 420, the evaluation system generates a set of candidate answers (e.g., corresponding to the data 360 of FIG. 3) for the question based on the determined context. For example, as discussed above, the evaluation system may process the question using one or more language models (e.g., the language models 355 of FIG. 3), conditioned based on the context, to generate the set of candidate answers.

At block 425, the evaluation system generates a set of regression scores (e.g., corresponding to the data 380 of FIG. 3) for the proposed answer provided in the query. For example, as discussed above, the evaluation system may process the answer and/or other data such as the context and the question using one or more regression models (e.g., the regression models 375 of FIG. 3) to generate regression scores indicating the probability that the proposed answer is acceptable based on a variety of criteria (e.g., the similarity between the proposed answer and the question, whether the proposed answer is in the same language or includes any disallowed topics, and the like).

At block 430, the evaluation system verifies the proposed answer (e.g., using the verification component 390 of FIG. 3) based on the query, the context, candidate answer(s), and/or the set of regression scores. For example, as discussed above, the evaluation system may compute similarity between the proposed answer and each of: the question, one or more hyperedges in the context, each of the candidate answers, and the like. In some embodiments, the evaluation system may aggregate these similarity scores and the regression scores to generate an overall conclusion indicating whether the proposed answer is correct.

At block 435, the evaluation system determines whether the proposed answer was verified. If so, the method 400 continues to block 445, where the evaluation system outputs the response indicating that the answer is correct. In some embodiments, as discussed above, the evaluation system may additionally output information such as the relevant portion(s) of the context supporting the answer.

Returning to block 435, if the evaluation system determines that the answer cannot be verified, the method 400 continues to block 440. At block 440, the evaluation system selects one of the candidate answers. As discussed above, the evaluation system may generally select the candidate answer using any suitable criteria, including randomly. In some embodiments, the evaluation system can compute similarity scores between each given candidate answer and one or more of: each other candidate answer, the question, the context, and the like. The evaluation system may then select the highest-scored candidate answer at block 440.

The method 400 then returns to block 425 to generate updated regression scores using the selected candidate answer, rather than the originally proposed answer. Similarly, at block 430, the evaluation system seeks to verify the selected candidate answer, rather than the proposed answer. As illustrated, this process of selecting and evaluating candidate answers may continue until one answer is verified. In some embodiments, rather than terminating when a candidate answer is verified, the evaluation system may continue to evaluate each other candidate answer until all candidate answers have been evaluated. The evaluation system may then select the candidate answer having the highest score as the best candidate answer for output.

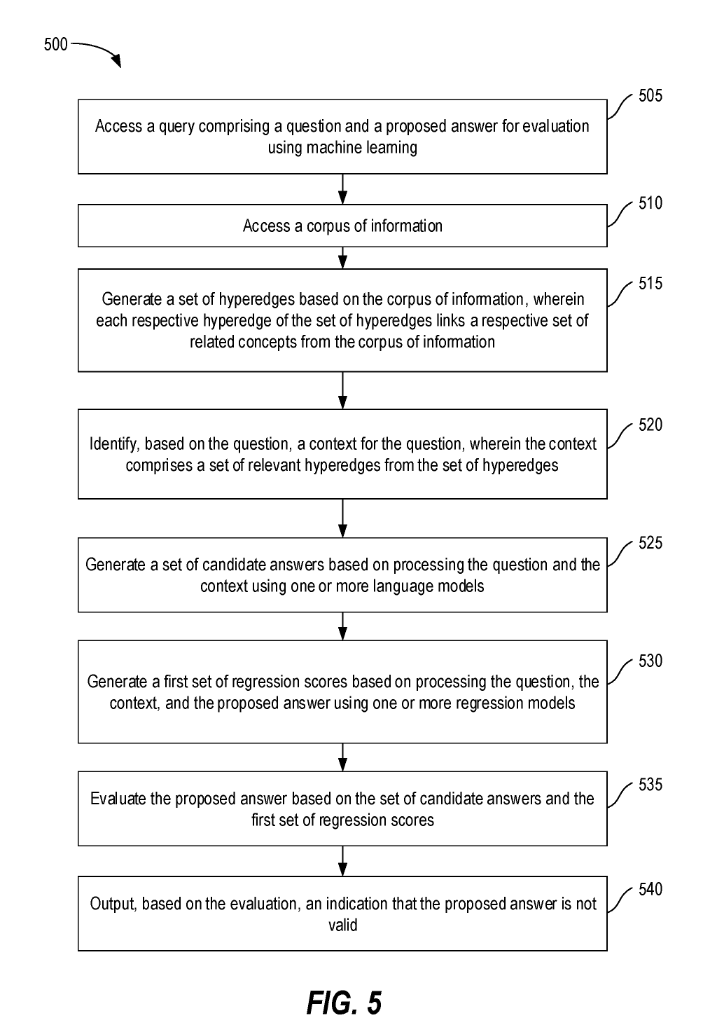

FIG. 5 is a flow diagram depicting an example method 500 for machine learning, according to some embodiments of the present disclosure. In some embodiments, the method 500 may be performed by an evaluation system, such as the language model federator 180 of FIG. 1, the evaluation system 210 of FIG. 2, and/or the evaluation system discussed above with reference to FIGS. 3-4.

At block 505, a query (e.g., the input 205 of FIG. 2 and/or the query 310 of FIG. 3) comprising a question and a proposed answer is accessed for evaluation using machine learning.

At block 510, a corpus of information (e.g., the corpus C discussed above with reference to FIG. 3) is accessed.

At block 515, a set of hyperedges (e.g., the data 325 of FIG. 3) is generated based on the corpus of information, wherein each respective hyperedge of the set of hyperedges links a respective set of related concepts from the corpus of information.

At block 520, based on the question, a context (e.g., the data 340 of FIG. 3) for the question is identified, wherein the context comprises a set of relevant hyperedges from the set of hyperedges.

At block 525, a set of candidate answers (e.g., the data 360 of FIG. 3) is generated based on processing the question and the context using one or more language models (e.g., the language models 355 of FIG. 3).

At block 530, a first set of regression scores (e.g., the data 380 of FIG. 3) is generated based on processing the question, the context, and the proposed answer using one or more regression models (e.g., the regression models 375 of FIG. 3).

At block 535, the proposed answer is evaluated based on the set of candidate answers and the first set of regression scores.

At block 540, based on the evaluation, an indication that the proposed answer is not valid is output.

While the foregoing is directed to embodiments of the present invention, other and further embodiments of the invention may be devised without departing from the basic scope thereof, and the scope thereof is determined by the claims that follow.

What is claimed is:

1. A method, comprising:
accessing a query comprising a question and a proposed answer for evaluation using machine learning;
accessing a corpus of information;
generating a set of hyperedges based on the corpus of information, wherein each respective hyperedge of the set of hyperedges links a respective set of related concepts from the corpus of information;
identifying, based on the question, a context for the question, wherein the context comprises a set of relevant hyperedges from the set of hyperedges;
generating a set of candidate answers based on processing the question and the context using one or more language models;
generating a first set of regression scores based on processing the question, the context, and the proposed answer using one or more regression models;
evaluating the proposed answer based on the set of candidate answers and the first set of regression scores; and
outputting, based on the evaluation, an indication that the proposed answer is not valid.

2. The method of claim 1, wherein identifying the context comprises searching the set of hyperedges, based on the question, using at least one of (i) keyword searching, (ii) structured query language searching, or (iii) semantic searching.

3. The method of claim 1, wherein the first set of regression scores comprises a first regression score indicating at least one of:
(i) similarity between the proposed answer and the context;
(ii) whether the proposed answer contains one or more disallowed concepts;
(iii) whether the question, proposed answer, and context are in a same language; or
(iv) whether the proposed answer contradicts the context.

4. The method of claim 1, wherein evaluating the proposed answer comprises:
generating a first set of similarity scores between the proposed answer and the set of candidate answers;
generating a second set of similarity scores between the proposed answer and the context;
generating a third set of similarity scores between the proposed answer and the question; and
aggregating the first, second, and third sets of similarity scores with the first set of regression scores.

5. The method of claim 1, further comprising outputting at least a portion of the context.

6. The method of claim 1, further comprising:
generating a second set of regression scores based on processing the question, the context, and a first candidate answer of the set of candidate answers using one or more regression models;
evaluating the first candidate answer based on the set of candidate answers and the second set of regression scores; and
outputting, based on the evaluation, the first candidate answer.

7. The method of claim 1, wherein the query and the corpus of information are indicated in a request from a user.

8. The method of claim 1, wherein generating the set of hyperedges comprises:
generating a hypergraph based on the corpus of information, wherein the hypergraph comprises:
a plurality of nodes representing concepts from the corpus of information,
a plurality of hyperedges representing relationships among the concepts from the corpus of information, wherein each respective hyperedge of the plurality of hyperedges comprises a respective probabilistic weight indicating a probability that a corresponding set of concepts are related; and
determining that the set of hyperedges, from the plurality of hyperedges, are coherent based on the probabilistic weights.

9. A computer program product comprising one or more tangible computer-readable storage media and program instructions stored on at least one of the one or more tangible computer-readable storage media, the program instructions executable by a processor to perform operations comprising:
accessing a query comprising a question and a proposed answer for evaluation using machine learning;
accessing a corpus of information;
generating a set of hyperedges based on the corpus of information, wherein each respective hyperedge of the set of hyperedges links a respective set of related concepts from the corpus of information;
identifying, based on the question, a context for the question, wherein the context comprises a set of relevant hyperedges from the set of hyperedges;
generating a set of candidate answers based on processing the question and the context using one or more language models;
generating a first set of regression scores based on processing the question, the context, and the proposed answer using one or more regression models;
evaluating the proposed answer based on the set of candidate answers and the first set of regression scores; and
outputting, based on the evaluation, an indication that the proposed answer is not valid.

10. The computer program product of claim 9, wherein identifying the context comprises searching the set of hyperedges, based on the question, using at least one of (i) keyword searching, (ii) structured query language searching, or (iii) semantic searching.

11. The computer program product of claim 9, wherein the first set of regression scores comprises a first regression score indicating at least one of:
(i) similarity between the proposed answer and the context;
(ii) whether the proposed answer contains one or more disallowed concepts;
(iii) whether the question, proposed answer, and context are in a same language; or
(iv) whether the proposed answer contradicts the context.

12. The computer program product of claim 9, wherein evaluating the proposed answer comprises:
generating a first set of similarity scores between the proposed answer and the set of candidate answers;
generating a second set of similarity scores between the proposed answer and the context;
generating a third set of similarity scores between the proposed answer and the question; and
aggregating the first, second, and third sets of similarity scores with the first set of regression scores.

13. The computer program product of claim 9, the operation further comprising:
generating a second set of regression scores based on processing the question, the context, and a first candidate answer of the set of candidate answers using one or more regression models;
evaluating the first candidate answer based on the set of candidate answers and the second set of regression scores; and
outputting, based on the evaluation, the first candidate answer.

14. The computer program product of claim 9, wherein generating the set of hyperedges comprises:
generating a hypergraph based on the corpus of information, wherein the hypergraph comprises:
a plurality of nodes representing concepts from the corpus of information,
a plurality of hyperedges representing relationships among the concepts from the corpus of information, wherein each respective hyperedge of the plurality of hyperedges comprises a respective probabilistic weight indicating a probability that a corresponding set of concepts are related; and
determining that the set of hyperedges, from the plurality of hyperedges, are coherent based on the probabilistic weights.

15. A system, comprising:
one or more processors; and
one or more memories storing a program, which, when executed on any combination of the one or more processors, performs operations, the operations comprising:
accessing a query comprising a question and a proposed answer for evaluation using machine learning;
accessing a corpus of information;
generating a set of hyperedges based on the corpus of information, wherein each respective hyperedge of the set of hyperedges links a respective set of related concepts from the corpus of information;
identifying, based on the question, a context for the question, wherein the context comprises a set of relevant hyperedges from the set of hyperedges;
generating a set of candidate answers based on processing the question and the context using one or more language models;
generating a first set of regression scores based on processing the question, the context, and the proposed answer using one or more regression models;
evaluating the proposed answer based on the set of candidate answers and the first set of regression scores; and
outputting, based on the evaluation, an indication that the proposed answer is not valid.

16. The system of claim 15, wherein identifying the context comprises searching the set of hyperedges, based on the question, using at least one of (i) keyword searching, (ii) structured query language searching, or (iii) semantic searching.

17. The system of claim 15, wherein the first set of regression scores comprises a first regression score indicating at least one of:
(i) similarity between the proposed answer and the context;
(ii) whether the proposed answer contains one or more disallowed concepts;
(iii) whether the question, proposed answer, and context are in a same language; or
(iv) whether the proposed answer contradicts the context.

18. The system of claim 15, wherein evaluating the proposed answer comprises:
generating a first set of similarity scores between the proposed answer and the set of candidate answers;
generating a second set of similarity scores between the proposed answer and the context;
generating a third set of similarity scores between the proposed answer and the question; and
aggregating the first, second, and third sets of similarity scores with the first set of regression scores.

19. The system of claim 15, the operation further comprising:
generating a second set of regression scores based on processing the question, the context, and a first candidate answer of the set of candidate answers using one or more regression models;
evaluating the first candidate answer based on the set of candidate answers and the second set of regression scores; and
outputting, based on the evaluation, the first candidate answer.

20. The system of claim 15, wherein generating the set of hyperedges comprises:
generating a hypergraph based on the corpus of information, wherein the hypergraph comprises:
a plurality of nodes representing concepts from the corpus of information,
a plurality of hyperedges representing relationships among the concepts from the corpus of information, wherein each respective hyperedge of the plurality of hyperedges comprises a respective probabilistic weight indicating a probability that a corresponding set of concepts are related; and
determining that the set of hyperedges, from the plurality of hyperedges, are coherent based on the probabilistic weights.
